(19) United States
(12) Patent Application Publication
(10) Pub. No.: US 2026/0032607 A1
(43) Pub. Date: Jan. 29, 2026

(54) UPLINK COMMUNICATION PRIORITIZATION FOR MULTIPLE TIMING ADVANCES

(71) Applicant: QUALCOMM Incorporated, San Diego, CA (US)

(72) Inventors: Shaozhen GUO, Beijing (CN); Mostafa KHOSHNEVISAN, San Diego, CA (US); Peter GAAL, San Diego, CA (US)

(21) Appl. No.: 19/099,958

(22) PCT Filed: Sep. 30, 2022
(86) PCT No.: PCT/CN2022/123004

§ 371 Date: Jan. 30, 2025

(51) Int. Cl. H04W 56/00

(52) U.S. Cl. CPC H04W 56/00

(57) ABSTRACT

Various aspects of the present disclosure generally relate to wireless communication. In some aspects, a user equipment (UE) may determine that a first uplink communication to be transmitted overlaps, at an overlapped duration in a time domain, a second uplink communication to be transmitted, the first uplink communication corresponding to a first timing advance (TA) group (TAG) and having a first uplink TA and the second uplink communication corresponding to a second TAG and having a second uplink TA. The UE may transmit at least a portion of the first uplink communication based at least in part on the first uplink communication satisfying a selection condition, the at least the portion of the first uplink communication comprising an overlapped portion of the first uplink communication corresponding to the overlapped duration. Numerous other aspects are described.

### FIELD OF THE DISCLOSURE

Aspects of the present disclosure generally relate to wireless communication and to techniques and apparatuses for uplink communication prioritization for multiple timing advances.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to determine that a first uplink communication to be transmitted overlaps, at an overlapped duration in a time domain, a second uplink communication to be transmitted, the first uplink communication corresponding to a first timing advance (TA) group (TAG) and having a first uplink TA and the second uplink communication corresponding to a second TAG and having a second uplink TA. The one or more processors may be configured to transmit at least a portion of the first uplink communication based at least in part on the first uplink communication satisfying a selection condition, the at least the portion of the first uplink communication comprising an overlapped portion of the first uplink communication corresponding to the overlapped duration.

Some aspects described herein relate to a method of wireless communication performed by an apparatus of a UE. The method may include determining that a first uplink communication to be transmitted overlaps, at an overlapped duration in a time domain, a second uplink communication to be transmitted, the first uplink communication corresponding to a first TAG and having a first uplink TA and the second uplink communication corresponding to a second TAG and having a second uplink TA. The method may include transmitting at least a portion of the first uplink communication based at least in part on the first uplink communication satisfying a selection condition, the at least the portion of the first uplink communication comprising an overlapped portion of the first uplink communication corresponding to the overlapped duration.

Some aspects described herein relate to a non-transitory computer-readable medium that stores a set of instructions for wireless communication by a UE. The set of instructions, when executed by one or more processors of the UE, may cause the UE to determine that a first uplink communication to be transmitted overlaps, at an overlapped duration in a time domain, a second uplink communication to be transmitted, the first uplink communication corresponding to a first TAG and having a first uplink TA and the second uplink communication corresponding to a second TAG and having a second uplink TA. The set of instructions, when executed by one or more processors of the UE, may cause the UE to transmit at least a portion of the first uplink communication based at least in part on the first uplink communication satisfying a selection condition, the at least the portion of the first uplink communication comprising an overlapped portion of the first uplink communication corresponding to the overlapped duration.

Some aspects described herein relate to an apparatus for wireless communication. The apparatus may include means for determining that a first uplink communication to be transmitted overlaps, at an overlapped duration in a time domain, a second uplink communication to be transmitted, the first uplink communication corresponding to a first TAG and having a first uplink TA and the second uplink communication corresponding to a second TAG and having a second uplink TA. The apparatus may include means for transmitting at least a portion of the first uplink communication based at least in part on the first uplink communication satisfying a selection condition, the at least the portion of the first uplink communication comprising an overlapped portion of the first uplink communication corresponding to the overlapped duration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of multi-downlink control information (DCI)-based multiple transmission reception point (mTRP) operation in accordance with the present disclosure.

FIG. 4 is a diagram illustrating an example associated with uplink communication prioritization for multiple timing advances, in accordance with the present disclosure.

FIG. 5 is a diagram illustrating an example process performed, for example, by a UE, in accordance with the present disclosure.

FIG. 6 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

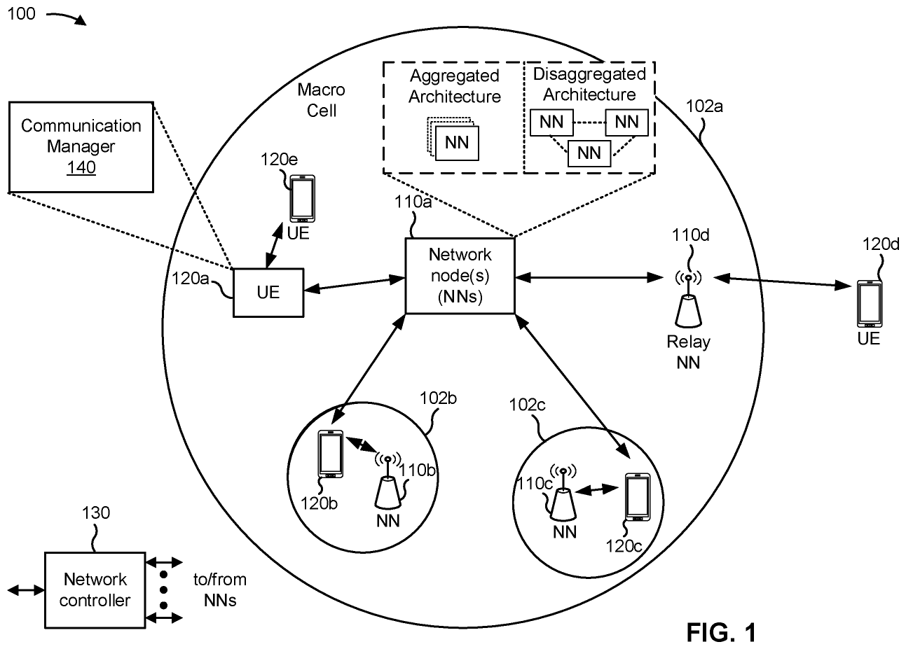

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may determine that a first uplink communication to be transmitted overlaps, at an overlapped duration in a time domain, a second uplink communication to be transmitted, the first uplink communication corresponding to a first timing advance (TA) group (TAG) and having a first uplink TA and the second uplink communication corresponding to a second TAG and having a second uplink TA; and transmit at least a portion of the first uplink communication based at least in part on the first uplink communication satisfying a selection condition, the at least the portion of the first uplink communication comprising an overlapped portion of the first uplink communication corresponding to the overlapped duration. Additionally, or alternatively, the communication manager 140 may perform one or more other operations described herein.

As indicated above, FIG. 1 is provided as an example. Other examples may differ from what is described with regard to FIG. 1.

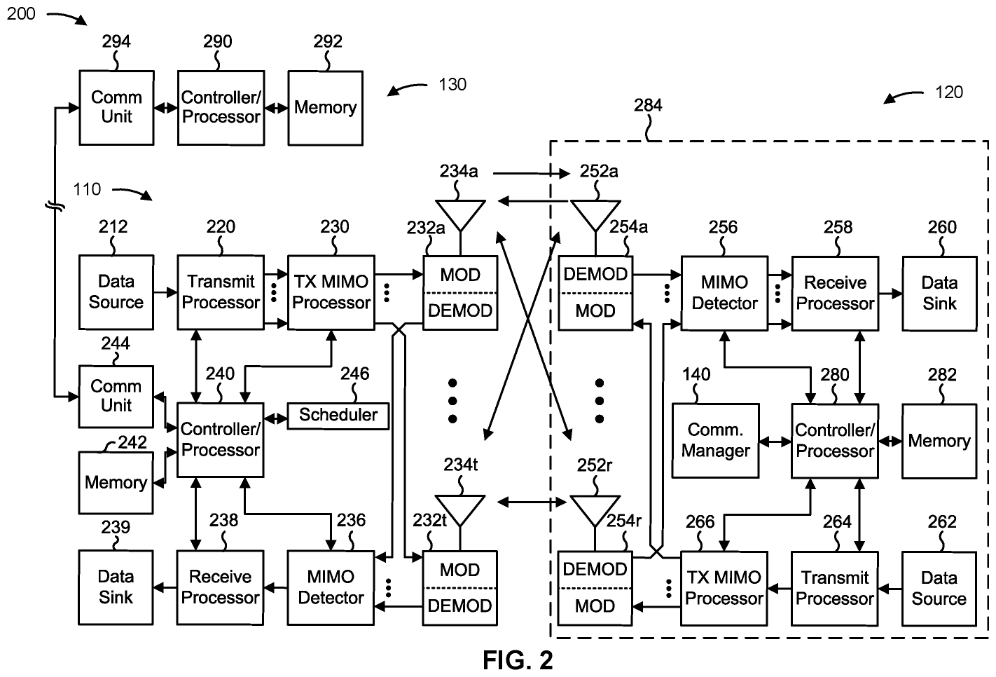

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of transmission configuration indicator (TCI) states that respectively indicate beams that may be used by the UE, such as for receiving a physical downlink shared channel (PDSCH). The base station may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-(SI-RS-Resourceld, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

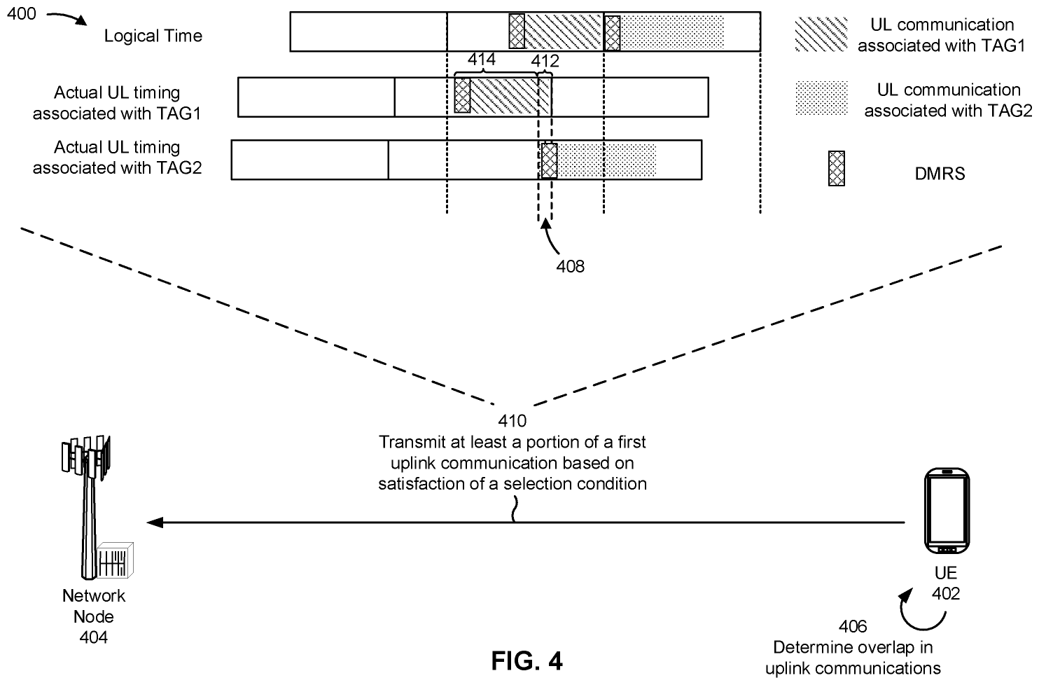

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-6).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-6).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

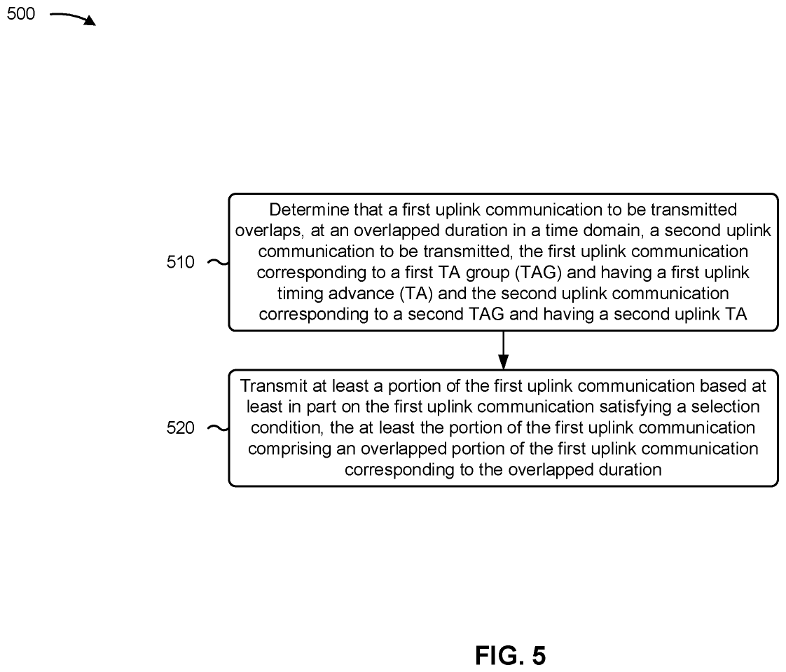

The controller/processor 240 of the network node 110, the controller/processor 280 of the UE 120, and/or any other component(s) of FIG. 2 may perform one or more techniques associated with uplink communication prioritization for multiple TAs, as described in more detail elsewhere herein. For example, the controller/processor 240 of the network node 110, the controller/processor 280 of the UE 120, and/or any other component(s) of FIG. 2 may perform or direct operations of, for example, process 500 of FIG. 5 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 500 of FIG. 5 and/or other processes as described herein. In some examples, executing instructions may include running the instructions, converting the instructions, compiling the instructions, and/or interpreting the instructions, among other examples.

In some aspects, a UE (e.g., the UE 120) includes means for determining that a first uplink communication to be transmitted overlaps, at an overlapped duration in a time domain, a second uplink communication to be transmitted, the first uplink communication corresponding to a first TAG and having a first uplink TA and the second uplink communication corresponding to a second TAG and having a second uplink TA; and/or means for transmitting at least a portion of the first uplink communication based at least in part on the first uplink communication satisfying a selection condition, the at least the portion of the first uplink communication comprising an overlapped portion of the first uplink communication corresponding to the overlapped duration. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

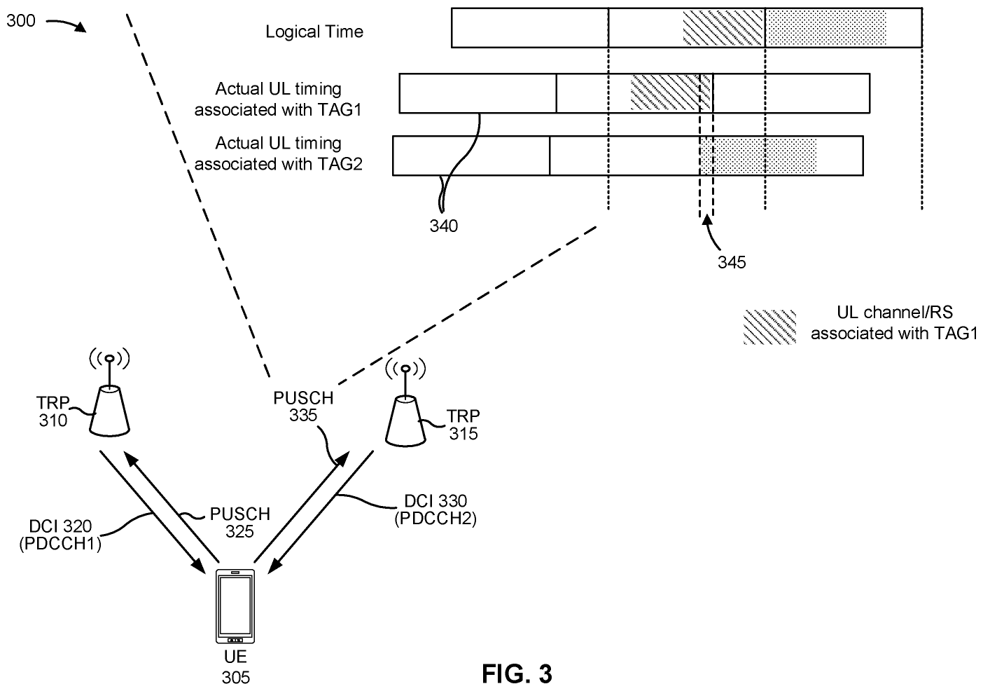

FIG. 3 is a diagram illustrating an example 300 of multi-DCI-based multiple TRP (mTRP) operation in accordance with the present disclosure. As shown, a UE 305 may communicate with a first TRP 310 and a second TRP 315. The UE 305 may be configured with multi-DCI-based mTRP operation. In some aspects, the TRP 310 and/or the TRP 315 may be, include, or be included in, one or more network nodes 110 described above in connection with FIGS. 1 and 2. For example, different TRPs 310 and 315 may be included in different network nodes 110. In some cases, multiple TRPs 310 and 315 may be included in a single network node 110. In some cases, a TRP 310 and/or a TRP 315 may be referred to as a cell, a panel, an antenna array, or an array. The UE 305 may be, include, or be included in the UE 120 described above in connection with FIGS. 1 and 2.

In some aspects, multiple TRPs 310 and 315 may transmit communications (for example, the same communication or different communications) in the same transmission time interval (TTI) (for example, a slot, a mini-slot, a subframe, or a symbol) or different TTIs using different QCL relationships (for example, different spatial parameters, different TCI states, different precoding parameters, or different beamforming parameters). In some aspects, a TCI state may be used to indicate one or more QCL relationships. A TRP 310 may be configured to individually (for example, using dynamic selection) or jointly (for example, using joint transmission with one or more other TRPs 310) serve traffic to a UE 305.

The UE 305 may be configured with multi-DCI-based mTRP operation. As shown, when configured with multi-DCI-based multi-TRP operation, the UE 305 may receive, from the first TRP 310, a first DCI transmission 320 in a first physical downlink control channel (PDCCH) (shown as “PDCCH1”), where the first DCI transmission 320 may schedule a first physical uplink shared channel (PUSCH) transmission 325 for transmitting to the first TRP 310. Similarly, the UE 305 may receive, from the second TRP 315, a second DCI transmission 330 in a second PDCCH (shown as “PDCCH2”), where the second DCI transmission 330 may schedule a second PUSCH transmission 335 for transmitting to the second TRP 315. In some cases, the first DCI transmission 320 may schedule a first PDSCH transmission and the second DCI transmission 330 may schedule a second PDSCH transmission. In association with monitoring DCIs transmitted from the first TRP 310 and the second TRP 315, the UE 305 may monitor PDCCH candidates in PDCCH monitoring occasions in a quantity of different control resource sets (CORESETs) pools, as configured by the network.

In some cases, the first TRP 310 may be associated with a serving cell of the UE 305. For example, the first TRP 310 may be a base station that provides the serving cell or a relay device that provides access to the serving cell. In some cases, a quantity of additional TRPs may be associated with a quantity of additional serving cells. In some cases, the second TRP 315 may be associated with a non-serving cell. To communicate with a cell and receive a DCI transmission, the UE 305 may acquire beam indications for beam selection based on a TCI state. In some cases, synchronization signal block (SSB) information may be used to perform channel measurement, obtain TCI state, or select beams for communication. The UE 305 may obtain SSB transmission position, SSB transmission periodicity, and SSB transmission power associated with the cell and use that information to facilitate receiving and decoding a DCI transmission.

In some scenarios, such as dual connectivity and/or carrier aggregation, different cells or uplink carriers may be configured in different TAGs. A TAG may refer to a set of uplink carriers that have the same (or similar within a threshold value) TA values. For example, a first uplink carrier and a second uplink carrier may have different propagation delays between the UE 305 and TRP 310 and between the UE 305 and the TRP 315, respectively. For example, a first serving cell (e.g., a primary cell (PCell)) for the first uplink carrier may be associated with the first TRP 310, and a second serving cell (e.g., an SCell) for the second uplink carrier may be associated with the second TRP 315, which is not co-located with the first TRP 310, resulting in different propagation delays for uplink transmissions to reach a respective TRP 310 or 315 on the different uplink carriers. As a result, the first uplink carrier and the second uplink carrier may have different TA values for uplink transmissions and may belong to different TAGs.

A UE 305 may use a TA value for an uplink carrier to transmit an uplink communication on the uplink carrier with a timing that results in synchronization of TTIs with a TRP 310 or 315, to reduce inter-TTI interference.

Uplink carriers can be transmitted asynchronously or synchronously. Two or more uplink carriers are typically synchronous when transmitted in the same subband. Two or more uplink carriers can be transmitted synchronously when a single TA command is used to control their timing. The transmission of two or more uplink carriers can be considered to be asynchronous with respect to one another when the transmission of one of the carriers lags the transmission of another of the carriers.

Multiple TAGs can be defined for the UE 305, which can be configured for carrier aggregation. A TAG typically comprises one or more uplink carriers controlled by the same TA commands transmitted from a TRP 310 and/or 315. TAGs can be configured by a serving TRP using dedicated signalling. A PDCCH order directed to an activated secondary cell in in a TAG can initiate a random access procedure that may result in the use of a physical random access channel (PRACH). A PDCCH order may be used, for example, after UL and DL resources have been released and the TRP 315 has DL data to send to the UE 305.

When multiple TAGs are defined for the UE 305, timing differences can exist between uplink carriers transmitted by the UE 305 because the one or more TAGS can have received a TA command different from the TA commands received by the other TAGs. TA commands can cause two or more TAGS to have timing offsets that are different from one another and these timing differences can be characterized as a relative delay between a pair of TAGs, or between corresponding component carriers, subframes, and/or symbols within the pair of TAGs.

In some cases, the UE 305 can follow the downlink frame timing change of a cell (which may be referred to as a “reference cell”) in a connected state. An uplink frame transmission can takes place (N_{TA}+N_{TAoffset})*T_{c} before reception of a first detected path (in time) of the corresponding downlink frame from the reference cell, where N_{TA} is a TA value obtained from a TA command, N_{TAoffset} is a TA offset value, and T_{c} is a time unit. For serving cells in a primary TAG, the UE 305 can use a special cell (SpCell) as the reference cell for deriving the UE transmit timing for cells in the primary TAG. For serving cell(s) in a secondary TAG, the UE 305 can use any of the activated secondary cells as the reference cell for deriving the UE transmit timing for the cells in the secondary TAG.

For example, a UE may be configured to handle at least a relative timing difference between slot timings of all pairs of one or more specified TAGs, given that the UE is configured with the primary TAG and secondary TAG for inter-band NR carrier aggregation in a standalone mode or a dual connectivity mode and/or configured with more than one secondary TAG for inter-band NR carrier aggregation in a dual connectivity mode. For intra-band non-contiguous NR carrier aggregation, a UE can be capable of handling at least a relative receive timing difference between slot timings of different carriers to be aggregated at the UE. For inter-band NR carrier aggregation, a UE can be capable of handling at least a relative receive timing difference between slot timing of all pairs of carriers to be aggregated at the UE.

In some cases, as shown, two uplink communications may be scheduled serially according to a logical time. However, once the respective uplink TAs are applied, the actual uplink timing of slot 340 associated with the respective communications may shift. For example, the uplink timing of a communication associated with a first TAG (TAG1) may be shifted with respect to a logical time and with respect to an uplink timing of a communication associated with a second TAG (TAG2). The first TAG may be, for example, associated with the TRP 310 and the second TAG may be associated with the TRP 315. The first uplink communication may overlap the second uplink communication in an overlapped duration 345. In some cases, the overlapped duration 345 can be one or more symbols 340 in length. In some cases, the overlapped duration 345 can be a partial symbol 340 in length (as shown). In some cases, the UE 305 may not be capable of simultaneous transmission of the two uplink communications on a same CC or on different CCs.

In some cases, dropping rules can be used to handle the overlapping between two UL transmissions associated with different TAGs. For example, the rules can include dropping the overlapped part or the whole transmission of the UL transmission that starts later in logical time or actual time, or dropping the overlapping part or the whole transmission of the UL transmission that is associated with a specific TRP. However, a DMRS can be located in a beginning of an uplink communication. Thus, if the overlapped part of the later-occurring uplink communication is dropped, the DMRS can be dropped, thereby negatively impacting demodulation and decoding performance of the network.

Some aspects of the techniques described herein provide for DMRS-aware prioritization of multiple uplink communications associated with multiple TAGs. In some aspects, for example, a UE may determine that two overlapping uplink communications (e.g., channels and/or signals) associated with different TAGs are to be transmitted in a same CC or different CCs. The first uplink communication may be associated with a first TAG and the second uplink communication may be associated with a second TAG. The first uplink communication and the second uplink communication, and their respective timings, may be determined to overlap based on applying a respective TA for each uplink communication. In some aspects, the UE may determine which of the two uplink communications to transmit based at least in part on a transmission condition being satisfied. The transmission condition may be based on the presence of DMRS symbols in one or more of the uplink communications. For example, in some aspects, the UE may determine which of the uplink communications to transmit based on the presence of DMRS symbols in an overlapped portion of one or more of the uplink communications. The determination may or may not impact non-overlapped portions (e.g., symbols and/or partial symbols) of the uplink communications. In this way, some aspects may facilitate selection of uplink communications to transmit in overlapping scenarios without unnecessarily dropping DMRSs. As a result, some aspects may have a positive impact on network performance including, for example, uplink transmission performance, demodulation performance, and decoding performance.

As indicated above, FIG. 3 is provided as an example. Other examples may differ from what is described with regard to FIG. 3.

FIG. 4 is a diagram illustrating an example associated with uplink communication prioritization for multiple TAs, in accordance with the present disclosure. As shown, a UE 402 may communicate with network node 404. The network node 404 may include any number of TRPs such as, for example, a first TRP and a second TRP, each of which may correspond to a respective TAG. In some aspects, the UE 402 may be similar to the UE 305 shown in FIG. 3. In some aspects, the network node 404 may be similar to the TRP 310 and/or the TRP 315.

As shown by reference number 406, the UE 402 may determining that a first uplink communication to be transmitted overlaps, at an overlapped duration 408 in a time domain, a second uplink communication to be transmitted. The first uplink communication may correspond to a first TAG and may have a first uplink TA. The second uplink communication may correspond to a second TAG and have a second uplink TA. The first uplink communication and second uplink communication may be determined after applying UCI multiplexing rule, UL dropping rule and resolving TDD-related DL-UL conflict.

As shown by reference number 410, the UE 402 may transmit, and the network node 404 may receive, at least a portion of the first uplink communication based at least in part on the first uplink communication satisfying a selection condition. The at least the portion of the first uplink communication may include an overlapped portion 412 of the first uplink communication corresponding to the overlapped duration 408. In some aspects, although the overlapped portion 412 of the first uplink communication is shown, in FIG. 4, as being an overlapped portion of the uplink communication associated with TAG1, the first uplink communication may be the uplink communication associated with TAG2. The “first uplink communication” refers to the communication that is selected (or, for which a portion is selected) for transmission. In some aspects, the UE 402 may transmit at least one additional portion of the first uplink communication. For example, the UE 402 may transmit a non-overlapped portion 414 of the first uplink communication.

In some aspects, the first uplink communication may start in a first time resource and the second uplink communication may start in a second time resource. The first uplink communication may satisfy the selection condition based on the first time resource occurring later than the second time resource. In some aspects, the first uplink communication may satisfy the selection condition based on the first uplink communication comprising a DMRS symbol associated with the overlapped duration.

In some aspects, a DMRS may not be included in the overlapped duration, and the first uplink communication may satisfy the selection condition based on the first uplink communication comprising a default communication. The first uplink communication may start in a first time resource and the second uplink communication may start in a second time resource, and the first uplink communication may be the default communication based on the first time resource occurring prior to the second time resource. In some aspects, the first uplink communication may be the default communication based on the first time resource occurring later than the second time resource. In some aspects, the first uplink communication may be the default communication based on the first uplink communication being associated with a fixed TAG or a fixed CORESET pool index. In some aspects, a first priority level may correspond to the first uplink communication and a second priority level may correspond to the second uplink communication. The first uplink communication may be the default communication based on the first priority level being greater than the second priority level. The first and second priority levels may be based on at least one of a channel characteristic, a reference signal type, or a physical priority. In some aspects, the first uplink communication may satisfy the selection condition based on the first uplink communication not including an SRS while the second uplink communication includes an SRS.

In some aspects, the overlapped portion of the first uplink communication may include a first DMRS and an overlapped portion of the second uplink communication may include a second DMRS. The first uplink communication may satisfy the selection condition based on the first uplink communication being a default uplink communication. In some aspects, for example, the default communication may be the communication that starts in earlier/later symbols, the communication associated with a fixed TAG or CORESET Pool Index value, or the communication with a higher priority level (e.g., based on channel/reference signal type or based on physical priority). In some aspects, the first uplink communication may satisfy the selection condition based on the second uplink communication including a physical uplink control channel (PUCCH) format 2 signal with more than one symbol, while the first uplink communication does not include a PUCCH format 2 signal. In some aspects, the first uplink communication may include a first DMRS size associated with a non-overlapped portion of the first uplink communication and the second uplink communication may include a second DMRS size associated with a non-overlapped portion of the second uplink communication. The first uplink communication may satisfy the selection condition based on the first DMRS size being smaller than the second DMRS size.

In some aspects, the UE 402 may refrain from transmitting an overlapped portion of the second uplink communication associated with the overlapped duration. The overlapped portion of the second uplink communication may correspond to at least a portion of a symbol. In some aspects, the UE 402 may refrain from transmitting the overlapped portion of the second uplink communication based on the second uplink communication comprising a PUCCH or a PUSCH. In some aspects, the UE 402 may refrain from transmitting the overlapped portion of the second uplink communication based on the overlapped portion of the second uplink communication not including a DMRS. In some aspects, the UE 402 may refrain from transmitting the overlapped portion of the second uplink communication based on an overlapped duration associated with the second uplink communication having a duration that is less than a cyclic prefix (CP) duration.

In some aspects, the overlapped portion of the second uplink communication may correspond to a set of symbols associated with the overlapped duration. The UE 402 may refrain from transmitting the overlapped portion of the second uplink communication based on an overlapped duration associated with the second uplink communication having a duration that is greater than a CP duration. The UE 402 may refrain from transmitting the overlapped portion of the second uplink communication based on the second uplink communication comprising an SRS.

In some aspects, the UE 402 may refrain from transmitting the second uplink communication. For example, the UE 402 may refrain from transmitting the second uplink communication based on the second uplink communication including a PUSCH or a PUCCH. In some aspects, the UE 402 may refrain from transmitting the second uplink communication based on the second uplink communication including a PUCCH format 1, a PUCCH format 3, or a PUCCH format 4.

In some aspects, the UE 402 may refrain from transmitting the second uplink communication based on a non-overlapped portion of the second uplink communication not comprising a DMRS. In some aspects, the UE 402 may refrain from transmitting the second uplink communication based on an overlapped duration associated with the second uplink communication having a duration that is greater than a CP duration. The UE 402 may refrain from transmitting the second uplink communication based on a whole DMRS symbol being dropped.

In some aspects, the first uplink communication may be associated with a first value of a communication attribute and the second uplink communication may be associated with a second value of the communication attribute. The communication attribute may include at least one of a channel, a reference signal type, or a physical priority level. In some aspects, the second value may be different from the first value, and the first uplink communication may satisfy the selection condition based on the first value of the communication attribute. In some aspects, the second value is equal to the first value, and the first uplink communication may satisfy the selection condition based on the overlapped portion of the first uplink communication including a DMRS. In some aspects, the first value may correspond to a time domain behavior associated with an SRS.

In some aspects, no DMRS may be included in either the first uplink communication or the second uplink communication, and the first uplink communication may satisfy the selection condition based on the first uplink communication being a default communication. In some aspects, the overlapped portion of the first uplink communication may include a first DMRS and an overlapped portion of the second uplink communication may include a second DMRS. The first uplink communication may satisfy the selection condition based on the first uplink communication being a default communication. In some aspects, a non-overlapped duration associated with the first uplink communication may include a first DMRS having a first DMRS duration in time and a non-overlapped duration associated with the second uplink communication may include a second DMRS having a second DMRS duration in time. The first uplink communication may satisfy the selection condition based on the first DMRS duration being less than the second DMRS duration.

As indicated above, FIG. 4 is provided as an example. Other examples may differ from what is described with respect to FIG. 4.

FIG. 5 is a diagram illustrating an example process 500 performed, for example, by a UE, in accordance with the present disclosure. Example process 500 is an example where the UE (e.g., UE 402) performs operations associated with uplink communication prioritization for multiple TAs.

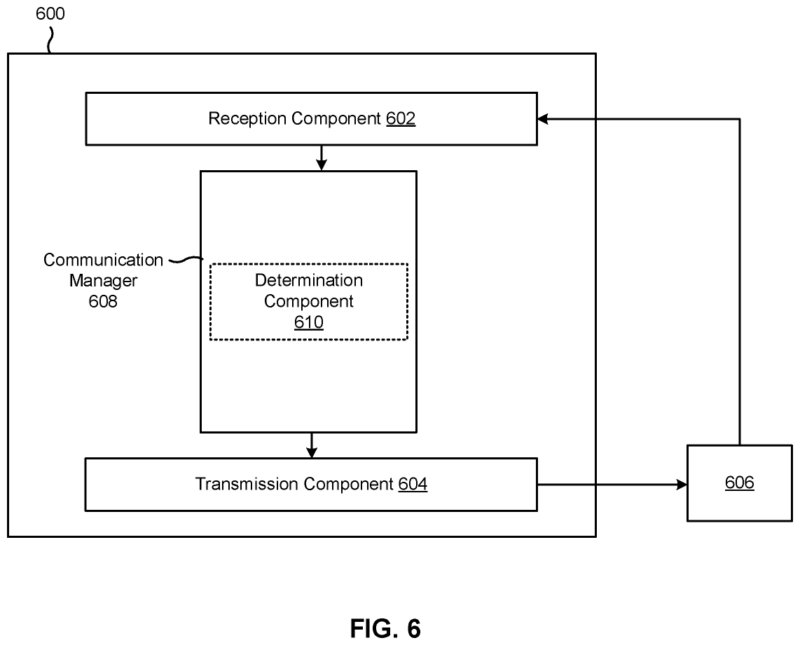

As shown in FIG. 5, in some aspects, process 500 may include determining that a first uplink communication to be transmitted overlaps, at an overlapped duration in a time domain, a second uplink communication to be transmitted, the first uplink communication corresponding to a first TAG and having a first uplink TA and the second uplink communication corresponding to a second TAG and having a second uplink TA (block 510). For example, the UE (e.g., using communication manager 608 and/or determination component 610, depicted in FIG. 6) may determine that a first uplink communication to be transmitted overlaps, at an overlapped duration in a time domain, a second uplink communication to be transmitted, the first uplink communication corresponding to a first TAG and having a first uplink TA and the second uplink communication corresponding to a second TAG and having a second uplink TA, as described above.

As further shown in FIG. 5, in some aspects, process 500 may include transmitting at least a portion of the first uplink communication based at least in part on the first uplink communication satisfying a selection condition, the at least the portion of the first uplink communication comprising an overlapped portion of the first uplink communication corresponding to the overlapped duration (block 520). For example, the UE (e.g., using communication manager 608 and/or transmission component 604, depicted in FIG. 6) may transmit at least a portion of the first uplink communication based at least in part on the first uplink communication satisfying a selection condition, the at least the portion of the first uplink communication comprising an overlapped portion of the first uplink communication corresponding to the overlapped duration, as described above.

Process 500 may include additional aspects, such as any single aspect or any combination of aspects described below and/or in connection with one or more other processes described elsewhere herein.

In a first aspect, process 500 includes transmitting at least one additional portion of the first uplink communication. In a second aspect, alone or in combination with the first aspect, the first uplink communication starts in a first time resource and the second uplink communication starts in a second time resource, and the first uplink communication satisfies the selection condition based on the first time resource occurring later than the second time resource. In a third aspect, alone or in combination with one or more of the first and second aspects, the first uplink communication satisfies the selection condition based on the first uplink communication comprising a DMRS symbol associated with the overlapped duration. In a fourth aspect, alone or in combination with one or more of the first through third aspects, a DMRS is not included in the overlapped duration, and the first uplink communication satisfies the selection condition based on the first uplink communication comprising a default communication.

In a fifth aspect, alone or in combination with the fourth aspect, the first uplink communication starts in a first time resource and the second uplink communication starts in a second time resource, and the first uplink communication comprises the default communication based on the first time resource occurring prior to the second time resource. In a sixth aspect, alone or in combination with the fourth aspect, the first uplink communication starts in a first time resource and the second uplink communication starts in a second time resource, and the first uplink communication comprises the default communication based on the first time resource occurring later than the second time resource.

In a seventh aspect, alone or in combination with the fourth aspect, the first uplink communication comprises the default communication based on the first uplink communication being associated with a fixed TAG. In an eighth aspect, alone or in combination with the fourth aspect, the first uplink communication comprises the default communication based on the first uplink communication being associated with a fixed CORESET pool index. In a ninth aspect, alone or in combination with the fourth aspect, a first priority level corresponds to the first uplink communication and a second priority level corresponds to the second uplink communication, and the first uplink communication comprises the default communication based on the first priority level being greater than the second priority level. In a tenth aspect, alone or in combination with the ninth aspect, the first priority level is based on at least one of a channel characteristic, a reference signal type, or a physical priority.

In an eleventh aspect, the first uplink communication satisfies the selection condition based on the first uplink communication not including an SRS, wherein the second uplink communication comprises an SRS. In a twelfth aspect, the overlapped portion of the first uplink communication comprises a first DMRS and an overlapped portion of the second uplink communication comprises a second DMRS, and the first uplink communication satisfies the selection condition based on the first uplink communication comprising a default uplink communication. In a thirteenth aspect, the first uplink communication satisfies the selection condition based on the second uplink communication comprising a PUCCH format 2 signal with more than one symbol, and the first uplink communication does not include a PUCCH format 2 signal. In a fourteenth aspect, the first uplink communication comprises a first DMRS size associated with a non-overlapped portion of the first uplink communication and the second uplink communication comprises a second DMRS size associated with a non-overlapped portion of the second uplink communication, and the first uplink communication satisfies the selection condition based on the first DMRS size being smaller than the second DMRS size.

In a fifteenth aspect, alone or in combination with one or more of the first through fourteenth aspects, process 500 includes refraining from transmitting an overlapped portion of the second uplink communication associated with the overlapped duration. In a sixteenth aspect, alone or in combination with the fifteenth aspect, the overlapped portion of the second uplink communication corresponds to at least a portion of a symbol. In a seventeenth aspect, alone or in combination with the fifteenth aspect, refraining from transmitting the overlapped portion of the second uplink communication comprises refraining from transmitting the overlapped portion of the second uplink communication based on the second uplink communication comprising a physical uplink control channel or a physical uplink shared channel.

In an eighteenth aspect, alone or in combination with the seventeenth aspect, refraining from transmitting the overlapped portion of the second uplink communication comprises refraining from transmitting the overlapped portion of the second uplink communication based on the overlapped portion of the second uplink communication not including a demodulation reference signal. In a nineteenth aspect, alone or in combination with the fifteenth aspect, refraining from transmitting the overlapped portion of the second uplink communication comprises refraining from transmitting the overlapped portion of the second uplink communication based on an overlapped duration associated with the second uplink communication having a duration that is less than a cyclic prefix duration.

In a twentieth aspect, alone or in combination with one or more of the fifteenth through nineteenth aspects, the overlapped portion of the second uplink communication corresponds to a set of symbols associated with the overlapped duration. In a twenty-first aspect, alone or in combination with the twentieth aspect, refraining from transmitting the overlapped portion of the second uplink communication comprises refraining from transmitting the overlapped portion of the second uplink communication based on an overlapped duration associated with the second uplink communication having a duration that is greater than a cyclic prefix duration. In a twenty-second aspect, alone or in combination with the twentieth aspect, refraining from transmitting the overlapped portion of the second uplink communication comprises refraining from transmitting the overlapped portion of the second uplink communication based on the second uplink communication comprising a sounding reference signal.

In a twenty-third aspect, alone or in combination with one or more of the first through twenty-second aspects, process 500 includes refraining from transmitting the second uplink communication. In a twenty-fourth aspect, alone or in combination with the twenty-third aspect, refraining from transmitting the second uplink communication comprises refraining from transmitting the second uplink communication based on the second uplink communication comprising a physical uplink shared channel or a PUCCH.

In a twenty-fifth aspect, alone or in combination with the twenty-fourth aspect, refraining from transmitting the second uplink communication comprises refraining from transmitting the second uplink communication based on the second uplink communication comprising a PUCCH format 1, a PUCCH format 3, or a PUCCH format 4. In a twenty-sixth aspect, alone or in combination with the twenty-fourth aspect, refraining from transmitting the second uplink communication comprises refraining from transmitting the second uplink communication based on a non-overlapped portion of the second uplink communication not comprising a demodulation reference signal. In a twenty-seventh aspect, alone or in combination with the twenty-third aspect, refraining from transmitting the second uplink communication comprises refraining from transmitting the second uplink communication based on an overlapped duration associated with the second uplink communication having a duration that is greater than a cyclic prefix duration. In a twenty-eighth aspect, alone or in combination with the twenty-third aspect, refraining from transmitting the second uplink communication comprises refraining from transmitting the second uplink communication based on a whole demodulation reference signal symbol being dropped.

In a twenty-ninth aspect, alone or in combination with one or more of the first through twenty-eighth aspects, the first uplink communication is associated with a first value of a communication attribute and the second uplink communication is associated with a second value of the communication attribute. In a thirtieth aspect, alone or in combination with the twenty-ninth aspect, the communication attribute comprises at least one of a channel, a reference signal type, or a physical priority level.

In a thirty-first aspect, alone or in combination with the twenty-ninth aspect, the second value is different from the first value, and the first uplink communication satisfies the selection condition based on the first value of the communication attribute. In a thirty-second aspect, alone or in combination with the twenty-ninth aspect, the second value is equal to the first value, and the first uplink communication satisfies the selection condition based on the overlapped portion of the first uplink communication comprising a demodulation reference signal.

In a thirty-third aspect, alone or in combination with the thirty-second aspect, the first value corresponds to a time domain behavior associated with a sounding reference signal. In a thirty-fourth aspect, alone or in combination with the thirty-second aspect, no demodulation reference signal is included in either the first uplink communication or the second uplink communication, and the first uplink communication satisfies the selection condition based on the first uplink communication comprising a default communication. In a thirty-fifth aspect, alone or in combination with the thirty-second aspect, the overlapped portion of the first uplink communication includes a first DMRS and an overlapped portion of the second uplink communication includes a second DMRS, and the first uplink communication satisfies the selection condition based on the first uplink communication comprising a default communication. In a thirty-sixth aspect, alone or in combination with the thirty-second aspect, a non-overlapped duration associated with the first uplink communication includes a first DMRS having a first DMRS duration in time and a non-overlapped duration associated with the second uplink communication includes a second DMRS having a second DMRS duration in time, and the first uplink communication satisfies the selection condition based on the first DMRS duration being less than the second DMRS duration.

In a thirty-seventh aspect, alone or in combination with one or more of the first through thirty-sixth aspects, the first uplink communication and the second uplink communication are on the same component carrier or different component carriers, and the UE is not capable of simultaneous transmission of the first uplink communication and the second uplink communication.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication, in accordance with the present disclosure. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include a communication manager 608. The communication manager 608 may include a determination component 610.

In some aspects, the apparatus 600 may be configured to perform one or more operations described herein in connection with FIG. 4. Additionally, or alternatively, the apparatus 600 may be configured to perform one or more processes described herein, such as process 500 of FIG. 5. In some aspects, the apparatus 600 and/or one or more components shown in FIG. 6 may include one or more components of the UE described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, a modem, a demodulator, a MIMO detector, a receive processor, a controller/processor, a memory, or a combination thereof, of the UE described in connection with FIG. 2.

The transmission component 604 may transmit communications, such as reference signals, control information, data communications, or a combination thereof, to the apparatus 606. In some aspects, one or more other components of the apparatus 600 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modem, a modulator, a transmit MIMO processor, a transmit processor, a controller/processor, a memory, or a combination thereof, of the UE described in connection with FIG. 2. In some aspects, the transmission component 604 may be co-located with the reception component 602 in a transceiver.

In some examples, means for transmitting, outputting, or sending (or means for outputting for transmission) may include one or more antennas, a modulator, a transmit MIMO processor, a transmit processor, or a combination thereof, of the UE described above in connection with FIG. 2.

In some examples, means for receiving (or means for obtaining) may include one or more antennas, a demodulator, a MIMO detector, a receive processor, or a combination thereof, of the UE described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for determining may include various processing system components, such as a receive processor, a transmit processor, a controller/processor, a memory, or a combination thereof, of the UE described above in connection with FIG. 2.

The communication manager 608 and/or the determination component 610 may determine that a first uplink communication to be transmitted overlaps, at an overlapped duration in a time domain, a second uplink communication to be transmitted, the first uplink communication corresponding to a first TAG and having a first uplink TA and the second uplink communication corresponding to a second TAG and having a second uplink TA. In some aspects, the communication manager 608 may include one or more antennas, a modem, a controller/processor, a memory, or a combination thereof, of the UE described in connection with FIG. 2. In some aspects, the communication manager 608 may include the reception component 602 and/or the transmission component 604. In some aspects, the communication manager 608 may be, be similar to, include, or be included in, the communication manager 140 depicted in FIGS. 1 and 2. In some aspects, the determination component 610 may include one or more antennas, a modem, a controller/processor, a memory, or a combination thereof, of the UE described in connection with FIG. 2. In some aspects, the determination component 610 may include the reception component 602 and/or the transmission component 604.

The communication manager 608 and/or the transmission component 604 may transmit at least a portion of the first uplink communication based at least in part on the first uplink communication satisfying a selection condition, the at least the portion of the first uplink communication comprising an overlapped portion of the first uplink communication corresponding to the overlapped duration. The communication manager 608 and/or the transmission component 604 may transmit at least one additional portion of the first uplink communication. The communication manager 608 and/or the transmission component 604 may refrain from transmitting an overlapped portion of the second uplink communication associated with the overlapped duration. The communication manager 608 and/or the transmission component 604 may refrain from transmitting the second uplink communication.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some Aspects of the present disclosure:
Aspect 1: A method of wireless communication performed by an apparatus of a user equipment (UE), comprising: determining that a first uplink communication to be transmitted overlaps, at an overlapped duration in a time domain, a second uplink communication to be transmitted, the first uplink communication corresponding to a first timing advance (TA) group (TAG) and having a first uplink TA and the second uplink communication corresponding to a second TAG and having a second uplink TA; and transmitting at least a portion of the first uplink communication based at least in part on the first uplink communication satisfying a selection condition, the at least the portion of the first uplink communication comprising an overlapped portion of the first uplink communication corresponding to the overlapped duration.
Aspect 2: The method of Aspect 1, further comprising transmitting at least one additional portion of the first uplink communication.
Aspect 3: The method of either of Aspects 1 or 2, wherein the first uplink communication starts in a first time resource and the second uplink communication starts in a second time resource, and wherein the first uplink communication satisfies the selection condition based on the first time resource occurring later than the second time resource.
Aspect 4: The method of any of Aspects 1-3, wherein the first uplink communication satisfies the selection condition based on the first uplink communication comprising a demodulation reference signal (DMRS) symbol associated with the overlapped duration.
Aspect 5: The method of any of Aspects 1-3, wherein a demodulation reference signal (DMRS) is not included in the overlapped duration, and wherein the first uplink communication satisfies the selection condition based on the first uplink communication comprising a default communication.
Aspect 6: The method of Aspect 5, wherein the first uplink communication starts in a first time resource and the second uplink communication starts in a second time resource, and wherein the first uplink communication comprises the default communication based on the first time resource occurring prior to the second time resource.
Aspect 7: The method of Aspect 5, wherein the first uplink communication starts in a first time resource and the second uplink communication starts in a second time resource, and wherein the first uplink communication comprises the default communication based on the first time resource occurring later than the second time resource.
Aspect 8: The method of Aspect 5, wherein the first uplink communication comprises the default communication based on the first uplink communication being associated with a fixed TAG.
Aspect 9: The method of Aspect 5, wherein the first uplink communication comprises the default communication based on the first uplink communication being associated with a fixed control resource set (CORESET) pool index.
Aspect 10: The method of Aspect 5, wherein a first priority level corresponds to the first uplink communication and a second priority level corresponds to the second uplink communication, and wherein the first uplink communication comprises the default communication based on the first priority level being greater than the second priority level.
Aspect 11: The method of Aspect 10, wherein the first priority level is based on at least one of a channel characteristic, a reference signal type, or a physical priority.
Aspect 12: The method of Aspect 1, wherein the first uplink communication satisfies the selection condition based on the first uplink communication not including a sounding reference signal (SRS), wherein the second uplink communication comprises an SRS.
Aspect 13: The method of Aspect 1, wherein the overlapped portion of the first uplink communication comprises a first demodulation reference signal (DMRS) and an overlapped portion of the second uplink communication comprises a second DMRS, and wherein the first uplink communication satisfies the selection condition based on the first uplink communication comprising a default uplink communication.
Aspect 14: The method of Aspect 1, wherein the first uplink communication satisfies the selection condition based on the second uplink communication comprising a physical uplink control channel (PUCCH) format 2 signal with more than one symbol, and wherein the first uplink communication does not include a PUCCH format 2 signal.
Aspect 15: The method of Aspect 1, wherein the first uplink communication comprises a first demodulation reference signal (DMRS) size associated with a non-overlapped portion of the first uplink communication and the second uplink communication comprises a second DMRS size associated with a non-overlapped portion of the second uplink communication, and wherein the first uplink communication satisfies the selection condition based on the first DMRS size being smaller than the second DMRS size.
Aspect 16: The method of any of Aspects 1-15, further comprising refraining from transmitting an overlapped portion of the second uplink communication associated with the overlapped duration.
Aspect 17: The method of Aspect 16, wherein the overlapped portion of the second uplink communication corresponds to at least a portion of a symbol.
Aspect 18: The method of Aspect 16, wherein refraining from transmitting the overlapped portion of the second uplink communication comprises refraining from transmitting the overlapped portion of the second uplink communication based on the second uplink communication comprising a physical uplink control channel or a physical uplink shared channel.
Aspect 19: The method of Aspect 18, wherein refraining from transmitting the overlapped portion of the second uplink communication comprises refraining from transmitting the overlapped portion of the second uplink communication based on the overlapped portion of the second uplink communication not including a demodulation reference signal.
Aspect 20: The method of Aspect 16, wherein refraining from transmitting the overlapped portion of the second uplink communication comprises refraining from transmitting the overlapped portion of the second uplink communication based on an overlapped duration associated with the second uplink communication having a duration that is less than a cyclic prefix duration.
Aspect 21: The method of any of Aspects 16-20, wherein the overlapped portion of the second uplink communication corresponds to a set of symbols associated with the overlapped duration.
Aspect 22: The method of Aspect 21, wherein refraining from transmitting the overlapped portion of the second uplink communication comprises refraining from transmitting the overlapped portion of the second uplink communication based on an overlapped duration associated with the second uplink communication having a duration that is greater than a cyclic prefix duration.
Aspect 23: The method of Aspect 21, wherein refraining from transmitting the overlapped portion of the second uplink communication comprises refraining from transmitting the overlapped portion of the second uplink communication based on the second uplink communication comprising a sounding reference signal.
Aspect 24: The method of any of Aspects 1-23, further comprising refraining from transmitting the second uplink communication.
Aspect 25: The method of Aspect 24, wherein refraining from transmitting the second uplink communication comprises refraining from transmitting the second uplink communication based on the second uplink communication comprising a physical uplink shared channel or a physical uplink control channel (PUCCH).
Aspect 26: The method of Aspect 25, wherein refraining from transmitting the second uplink communication comprises refraining from transmitting the second uplink communication based on the second uplink communication comprising a PUCCH format 1, a PUCCH format 3, or a PUCCH format 4.
Aspect 27: The method of Aspect 25, wherein refraining from transmitting the second uplink communication comprises refraining from transmitting the second uplink communication based on a non-overlapped portion of the second uplink communication not comprising a demodulation reference signal.
Aspect 28: The method of Aspect 24, wherein refraining from transmitting the second uplink communication comprises refraining from transmitting the second uplink communication based an overlapped duration associated with the second uplink communication having a duration that is greater than a cyclic prefix duration.
Aspect 29: The method of Aspect 24, wherein refraining from transmitting the second uplink communication comprises refraining from transmitting the second uplink communication based on a whole demodulation reference signal symbol being dropped.
Aspect 30: The method of any of Aspects 1-29, wherein the first uplink communication is associated with a first value of a communication attribute and the second uplink communication is associated with a second value of the communication attribute.
Aspect 31: The method of Aspect 30, wherein the communication attribute comprises at least one of a channel, a reference signal type, or a physical priority level.
Aspect 32: The method of Aspect 30, wherein the second value is different from the first value, and wherein the first uplink communication satisfies the selection condition based on the first value of the communication attribute.
Aspect 33: The method of Aspect 30, wherein the second value is equal to the first value, and wherein the first uplink communication satisfies the selection condition based on the overlapped portion of the first uplink communication comprising a demodulation reference signal.
Aspect 34: The method of Aspect 33, wherein the first value corresponds to a time domain behavior associated with a sounding reference signal.
Aspect 35: The method of Aspect 33, wherein no demodulation reference signal is included in either the first uplink communication or the second uplink communication, and wherein the first uplink communication satisfies the selection condition based on the first uplink communication comprising a default communication.
Aspect 36: The method of Aspect 33, wherein the overlapped portion of the first uplink communication includes a first demodulation reference signal (DMRS) and an overlapped portion of the second uplink communication includes a second DMRS, and wherein the first uplink communication satisfies the selection condition based on the first uplink communication comprising a default communication.
Aspect 37: The method of Aspect 33, wherein a non-overlapped duration associated with the first uplink communication includes a first demodulation reference signal (DMRS) having a first DMRS duration in time and a non-overlapped duration associated with the second uplink communication includes a second DMRS having a second DMRS duration in time, and wherein the first uplink communication satisfies the selection condition based on the first DMRS duration being less than the second DMRS duration.
Aspect 38: The method of any of Aspects 1-37, wherein the first uplink communication and the second uplink communication are on a same component carrier or different component carriers, and the UE is not capable of simultaneous transmission of the first uplink communication and the second uplink communication.
Aspect 39: An apparatus for wireless communication at a device, comprising a processor; memory coupled with the processor; and instructions stored in the memory and executable by the processor to cause the apparatus to perform the method of one or more of Aspects 1-38.
Aspect 40: A device for wireless communication, comprising a memory and one or more processors coupled to the memory, the one or more processors configured to perform the method of one or more of Aspects 1-38.
Aspect 41: An apparatus for wireless communication, comprising at least one means for performing the method of one or more of Aspects 1-38.
Aspect 42: A non-transitory computer-readable medium storing code for wireless communication, the code comprising instructions executable by a processor to perform the method of one or more of Aspects 1-38.
Aspect 43: A non-transitory computer-readable medium storing a set of instructions for wireless communication, the set of instructions comprising one or more instructions that, when executed by one or more processors of a device, cause the device to perform the method of one or more of Aspects 1-38.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
determine that a first uplink communication to be transmitted overlaps, at an overlapped duration in a time domain, a second uplink communication to be transmitted, the first uplink communication corresponding to a first timing advance (TA) group (TAG) and having a first uplink TA and the second uplink communication corresponding to a second TAG and having a second uplink TA; and
transmit at least a portion of the first uplink communication based at least in part on the first uplink communication satisfying a selection condition, the at least the portion of the first uplink communication comprising an overlapped portion of the first uplink communication corresponding to the overlapped duration.

2. (canceled)

3. The UE of claim 1, wherein the first uplink communication starts in a first time resource and the second uplink communication starts in a second time resource, and wherein the first uplink communication satisfies the selection condition based on the first time resource occurring later than the second time resource.

4. The UE of claim 1, wherein the first uplink communication satisfies the selection condition based on the first uplink communication comprising a demodulation reference signal (DMRS) symbol associated with the overlapped duration.

5. The UE of claim 1, wherein a demodulation reference signal (DMRS) is not included in the overlapped duration, and wherein the first uplink communication satisfies the selection condition based on the first uplink communication comprising a default communication.

6. The UE of claim 5, wherein the first uplink communication starts in a first time resource and the second uplink communication starts in a second time resource, and wherein the first uplink communication comprises the default communication based on the first time resource occurring prior to the second time resource.

7. The UE of claim 5, wherein the first uplink communication starts in a first time resource and the second uplink communication starts in a second time resource, and wherein the first uplink communication comprises the default communication based on the first time resource occurring later than the second time resource.

8. The UE of claim 5, wherein the first uplink communication comprises the default communication based on the first uplink communication being associated with a fixed TAG.

9. The UE of claim 5, wherein the first uplink communication comprises the default communication based on the first uplink communication being associated with a fixed control resource set (CORESET) pool index.

10. The UE of claim 5, wherein a first priority level corresponds to the first uplink communication and a second priority level corresponds to the second uplink communication, and wherein the first uplink communication comprises the default communication based on the first priority level being greater than the second priority level.

11. (canceled)

12. The UE of claim 1, wherein the first uplink communication satisfies the selection condition based on the first uplink communication not including a sounding reference signal (SRS), wherein the second uplink communication comprises an SRS.

13. The UE of claim 1, wherein the overlapped portion of the first uplink communication comprises a first demodulation reference signal (DMRS) and an overlapped portion of the second uplink communication comprises a second DMRS, and wherein the first uplink communication satisfies the selection condition based on the first uplink communication comprising a default uplink communication.

14. The UE of claim 1, wherein the first uplink communication satisfies the selection condition based on the second uplink communication comprising a physical uplink control channel (PUCCH) format 2 signal with more than one symbol, and wherein the first uplink communication does not include a PUCCH format 2 signal.

15. The UE of claim 1, wherein the first uplink communication comprises a first demodulation reference signal (DMRS) size associated with a non-overlapped portion of the first uplink communication and the second uplink communication comprises a second DMRS size associated with a non-overlapped portion of the second uplink communication, and wherein the first uplink communication satisfies the selection condition based on the first DMRS size being smaller than the second DMRS size.

16-37. (canceled)

38. The UE of claim 1, wherein the first uplink communication and the second uplink communication are on a same component carrier or different component carriers, and the UE is not capable of simultaneous transmission of the first uplink communication and the second uplink communication.

39. A method of wireless communication performed by an apparatus of a user equipment (UE), comprising:
determining that a first uplink communication to be transmitted overlaps, at an overlapped duration in a time domain, a second uplink communication to be transmitted, the first uplink communication corresponding to a first timing advance (TA) group (TAG) and having a first uplink TA and the second uplink communication corresponding to a second TAG and having a second uplink TA; and
transmitting at least a portion of the first uplink communication based at least in part on the first uplink communication satisfying a selection condition, the at least the portion of the first uplink communication comprising an overlapped portion of the first uplink communication corresponding to the overlapped duration.

40. (canceled)

41. The method of claim 39, wherein the first uplink communication starts in a first time resource and the second uplink communication starts in a second time resource, and wherein the first uplink communication satisfies the selection condition based on the first time resource occurring later than the second time resource.

42. The method of claim 39, wherein the first uplink communication satisfies the selection condition based on the first uplink communication comprising a demodulation reference signal (DMRS) symbol associated with the overlapped duration.

43-49. (canceled)

50. The method of claim 39, wherein the first uplink communication satisfies the selection condition based on the first uplink communication not including a sounding reference signal (SRS), wherein the second uplink communication comprises an SRS.

51. (canceled)

52. The method of claim 39, wherein the first uplink communication satisfies the selection condition based on the second uplink communication comprising a physical uplink control channel (PUCCH) format 2 signal with more than one symbol, and wherein the first uplink communication does not include a PUCCH format 2 signal.

53-76. (canceled)

77. A non-transitory computer-readable medium storing a set of instructions for wireless communication, the set of instructions comprising:
one or more instructions that, when executed by one or more processors of a user equipment (UE), cause the UE to:
determine that a first uplink communication to be transmitted overlaps, at an overlapped duration in a time domain, a second uplink communication to be transmitted, the first uplink communication corresponding to a first timing advance (TA) group (TAG) and having a first uplink TA and the second uplink communication corresponding to a second TAG and having a second uplink TA; and
transmit at least a portion of the first uplink communication based at least in part on the first uplink communication satisfying a selection condition, the at least the portion of the first uplink communication comprising an overlapped portion of the first uplink communication corresponding to the overlapped duration.

78. (canceled)
